(19) United States
(12) Patent Application Publication
(10) Pub. No.: US 2003/0205518 A1
(43) Pub. Date: Nov. 6, 2003

(54) Water filter assembly

(76) Inventors: Karen J. VanderKooi, Grand Rapids, MI (US); Roy W. Kuennen, Caledonia, MI (US); Steve O. Mork, Lowell, MI (US)

Correspondence Address: ALTICOR INC., 7575 FULTON STREET EAST MAILCODE 78-2G, ADA, MI, 49355, US

(21) Appl. No.: 10/140,123

(22) Filed: May 6, 2002

(51) Int. Cl. B01D 29/58

(52) U.S. Cl. 210/315; 210/489; 210/493.1; 210/502.1

(57) ABSTRACT

A filter assembly designed for use in a water treatment system is provided. The assembly includes an inner carbon-based filter and an outer replaceable pleated filter. Untreated water flows first through the outer filter, which traps particulates, and then through the inner carbon-based filter, which traps particulates and adsorbs contaminants from the water. The outer filter is intended to be easily removed from the inner filter, so that the outer filter can be removed and cleaned or replaced when plugged with particulates. It is emphasized that this abstract is provided to comply with the rules requiring an abstract that will allow a searcher or other reader to quickly ascertain the subject matter of the technical disclosure. It is submitted with the understanding that it will not be used to interpret or limit the scope or meaning of the claims. 37 C.F.R. 1.72(b).

### BACKGROUND OF THE INVENTION

The present invention relates to filters, and more particularly to a filter assembly comprised of an inner carbon-based filter and a removable outer pleated filter.

The use of water treatment systems continues to rise throughout the United States and abroad. Carbon-based filters are often used in these water treatment systems because they are able to effectively remove particulate matter and contaminants from the water stream. Typically, these carbon-based filters may be comprised of a loose granular activated carbon bed or a pressed or extruded activated carbon block. Those skilled in art would recognize that the carbon-based filter could be manufactured or assembled using many methods. These carbon-based filters are often designed to reside within the filter housing of a water treatment system. The untreated water enters the filter housing and is directed through the carbon-based filter where a combination of mechanical filtration and adsorbtion operate to remove particulates and contaminants from the water. Examples of such water treatment systems can be found in U.S. Pat. No. 5,698,091 to Kuennen et al, the subject matter of which is incorporated herein by reference.

Carbon-based filters are useful so long as they are able to effectively remove particulates and reduce contaminants from the untreated water stream. The useful life of the filter is generally determined by the total volume of water that has passed through the carbon-based filter. After a predetermined volume of water has passed through the filter, it is assumed that the filter has become saturated with particulates and/or contaminants, and is therefore no longer able to effectively serve its useful purpose. At this point, the filter has reached the end-of-life, and must be replaced. However, if the water being filtered is highly turbid, the carbon filter may become prematurely plugged with particulates. This premature plugging can inhibit or even prevent the flow of water through the filter, which may lead to the replacement of the filter before its rated lifespan has been reached.

Attempts have been made to solve this problem by providing an outer wrap filter which encloses the carbon filter. The wrap filter is generally comprised of a material with a large micron rating and acts to remove particulates from the water before it enters the carbon filter. However, these outer wrap filters provide only a minimal surface area and therefore become readily plugged with particulates. In addition, these outer wrap filters often do not provide a positive seal around the carbon-based filter, thereby allowing unfiltered water to flow directly to the carbon-based filter, thereby defeating the purpose of the outer wrap filter.

Some carbon filters include integral pre-filters which remove particulates from the untreated water prior to flow through the carbon block. However, once these integral pre-filters become plugged, the entire filter assembly, including the pre-filter and carbon-based filter, must be replaced. Again, the relatively costly carbon-based filter is replaced before it has actually reached the end of its rated life. Examples of such filters can be found in U.S. Pat. No. 4,753,728 to VanderBilt et al, the subject matter of which is incorporated herein by reference.

A number of water treatment systems include pre-filters which are installed in a housing separate from the housing which encloses the carbon filter. Water flows first through the pre-filter housing, where the pre-filter functions to remove larger particulates. The water then flows through the carbon-based filter housing, where the carbon filter removes the smaller particulates and contaminants. This configuration allows the removal and replacement of the pre-filter without removing or replacing the carbon filter. However, these treatment systems are made larger and more complex by the addition of a separate pre-filter housing and accompanying plumbing. Examples of such filters can be found in U.S. Pat. No. 6,001,249 to Bailey et al.

It is therefore desirable to provide a carbon filter with a removable outer pre-filter for use in water treatment systems. It is further desirable that this removable outer pre-filter be cleanable or replaceable so that if it becomes plugged with particulates, the user can remove and clean or replace the outer filter without replacing the carbon filter. It is further desirable that the removable outer pre-filter and the carbon filter both reside within a common filter housing.

### SUMMARY OF THE INVENTION

This invention relates to a filter assembly for use in a water treatment system. More particularly, the present invention is directed to an assembly comprised of an outer replaceable pre-filter, an inner carbon-based filter adapted to fit within the outer pre-filter, an attachment device for attaching the outer pre-filter to the inner carbon-based filter, and one or more cylindrical straps that wrap around the perimeter of the outer pre-filter.

The inner carbon-based filter is generally cylindrical in shape and may be comprised of a pressed or extruded hollow core block of bonded activated carbon, or a permeable cylindrical housing containing a loose granular bed of activated carbon. Those skilled in arts would recognize that the carbon-based filter could be manufactured or assembled using many methods. The carbon filter is further comprised of one or more end caps comprised of a rigid non-porous material such as polypropylene. The inner carbon-based filter end caps are generally circular in shape and are glued or otherwise attached to the inner carbon filter. The top inner carbon-based filter end cap is further comprised of a concentric raised cylindrical section that is threaded or otherwise constructed to accommodate an attachment device.

The outer filter is generally cylindrical in shape and is comprised of a material which is pre-pleated or capable of being pleated, with the pleats running parallel to the major axis of the filter. The outer filter is further comprised of two end caps which are made from a rigid non-porous material, such as polypropylene, and are glued or otherwise attached to each end the outer filter.

The filter assembly is further comprised of a one or more devices, such as cylindrical straps or webbing, which are made from a material such as polyester or nylon. These devices fit closely around the circumference of the outer filter, and are designed to prevent undue circumferential expansion of the outer filter without substantially inhibiting the volume of water flow through the filter assembly.

### BRIEF DESCRIPTION OF THE DRAWINGS

FIG. 1 is an exploded perspective view of the filter assembly of the present invention.

FIG. 2 is an elevation view of the inner carbon-based filter.

FIG. 3 is a top perspective view of the inner carbon-based filter.

FIG. 4 is an elevation view of the inner carbon-based filter top end cap.

FIG. 5 is a bottom perspective view of the inner carbon-based filter top end cap.

FIG. 6 is an elevation view of the inner carbon-based filter bottom end cap.

FIG. 7 is a top perspective view of the inner carbon-based filter bottom end cap.

FIG. 8 is an elevation view of the outer filter.

FIG. 9 is a top perspective view of the outer filter.

FIG. 10 is an elevation view of the outer filter top end cap.

FIG. 11 is a top perspective view of the outer filter top end cap.

FIG. 12 is an elevation view of the outer filter bottom end cap.

FIG. 13 is a top perspective view of the outer filter bottom end cap.

### DETAILED DESCRIPTION OF THE ILLUSTRATED EMBODIMENT

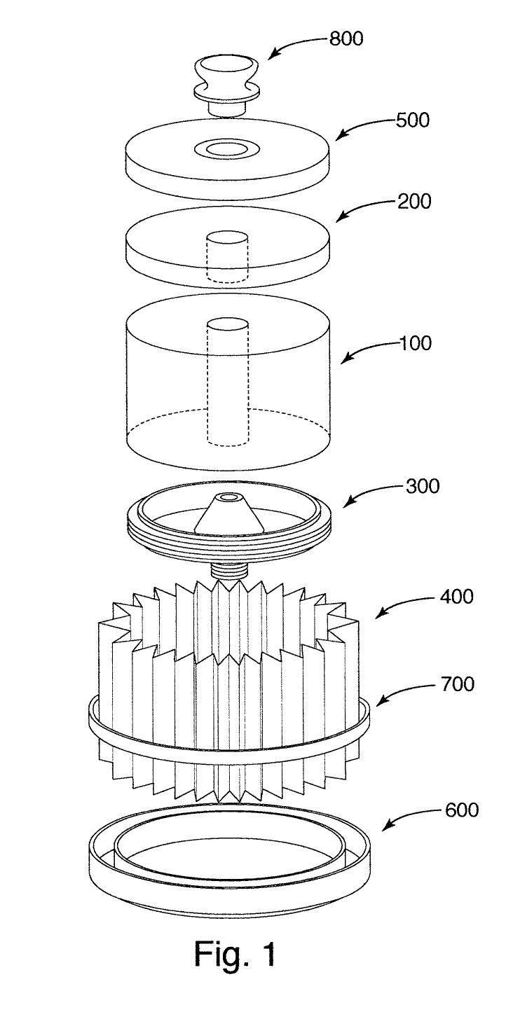

With reference now to the figures, and in particular to FIG. 1, the filter assembly of the present invention is illustrated at 10. The filter assembly 10 is comprised of inner filter element 100, outer filter element 400, a removable attachment device 800, and one or more cylindrical straps 700. Inner filter element 100 includes inner top end cap 200 and inner bottom end cap 300. Outer filter element 400 includes outer top end cap 500 and outer bottom end cap 600. Outer filter element 400 is designed to closely surround the inner filter element 100 such that both share a common longitudinal axis. One or more cylindrical straps 700 fit circumferentially about outer filter element 400 between outer top end cap 500 and outer bottom end cap 600.

With further reference to FIG. 1, cylindrical straps 700 are generally cylindrical in shape, and are comprised of a flexible material, such as polyester or nylon, and are glued or otherwise attached to the outer surface of outer filter element 400. A polyethylene based adhesive is used for attaching cylindrical strap 700 to outer filter element 400, although any suitable adhesive may be employed.

With further reference to FIG. 1, attachment device 800 may be a threaded bolt, a screw, a clip, a clasp, a magnet, or any other fastener capable of being removably attached to inner top end cap 200.

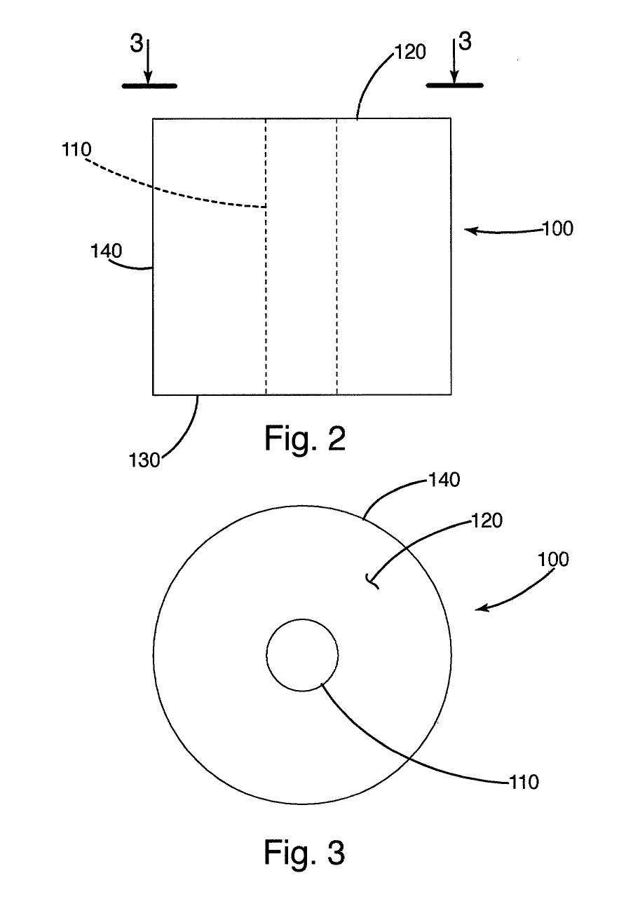

With reference now to FIGS. 2 and 3, inner filter element 100 is comprised of a carbon-based filter, such as a pressed or extruded hollow block of activated carbon having a specific pore size distribution and binder, and having a radial inward flow path. Inner filter element 100 is generally cylindrical in shape and defines a filter central bore 110 parallel to the central axis, a top surface 120, a bottom surface 130, and an outer surface 140.

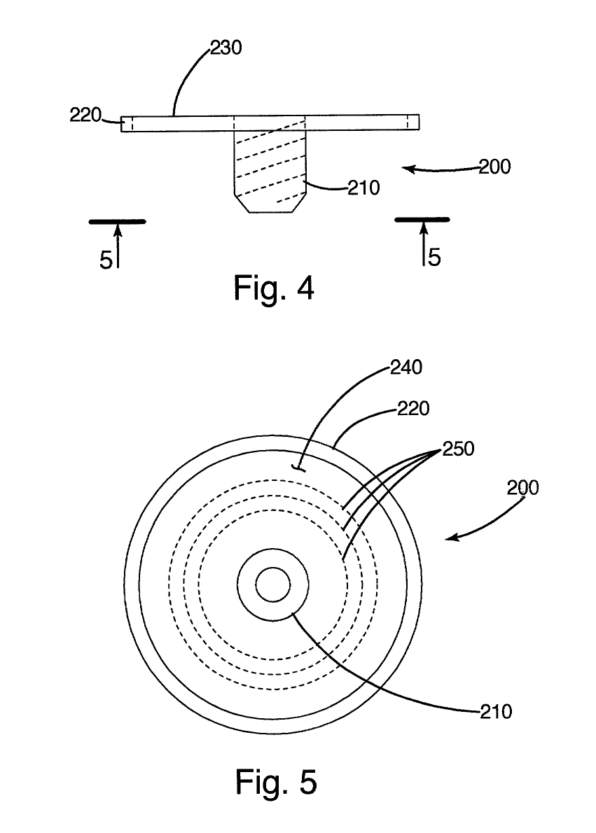

With additional reference now to FIGS. 4 and 5, inner top end cap 200 is generally circular in shape, with an outer surface 230, an inner surface 240, and a raised lip 220. Inner top end cap 200 of the illustrated embodiment is further comprised of a concentric raised section 210. Concentric raised section 210 may be cylindrical or conical in shape. The interior of concentric raised section 210 may be threaded or otherwise constructed to accommodate an attachment device 800. Inner surface 240 is further comprised of a plurality of concentric raised ridges 250. Inner surface 240 is glued or otherwise attached to top surface 120 of inner filter element 100, with raised lip 220 extending partially over outer surface 140 of inner filter element 100, and concentric raised section 210 fitting within filter central bore 110 of inner filter element 100. One suitable adhesive used to attach inner top end cap 200 to inner filter element 100 is a polyethylene-based adhesive, although any suitable adhesive may be employed.

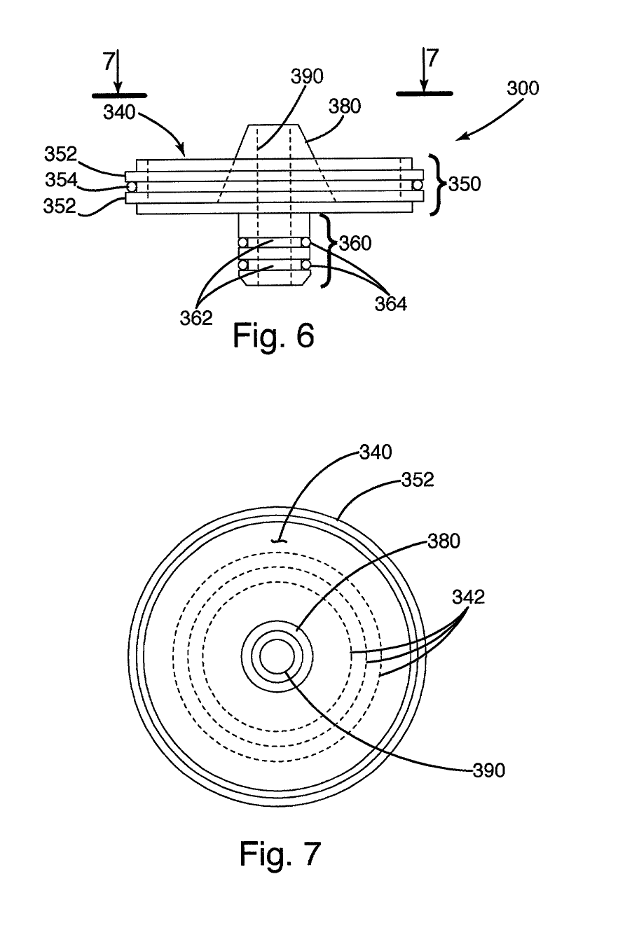

With reference now to FIGS. 6 and 7, it is illustrated that the inner bottom end cap 300 is generally circular in shape, with a raised lip 350, an inner surface 340, and an end cap central bore 390. Inner surface 340 is further comprised of a plurality of concentric raised ridges 342. Inner bottom end cap 300 is further comprised of a hollow raised section 380 which is molded to inner surface 340. Hollow raised section 380 may be cylindrical, truncated conical, or any other suitable shape. With specific reference now to FIG. 6, it is illustrated that the water filter outlet 360 is molded to the inner bottom end cap 300, and generally includes one or more annular recesses 362 which capture elastomeric, resilient sealing O-rings 364. With further reference to FIG. 6, it is illustrated that raised lip 350 is molded with one or more annular shoulders 352 which capture elastomeric, resilient sealing O-rings 354. Inner surface 340 is glued or otherwise attached to bottom surface 130 of inner filter element 100, with raised lip 350 extending partially over outer surface 140 of inner filter element 100, and hollow raised section 380 extending partially within filter central bore 110 of inner filter element 100, such that filter central bore 110 is in fluid communication with end cap central bore 390. One suitable adhesive used to attach inner bottom end cap 300 to inner filter element 100 is a polyethylene-based adhesive, although any suitable adhesive may be employed.

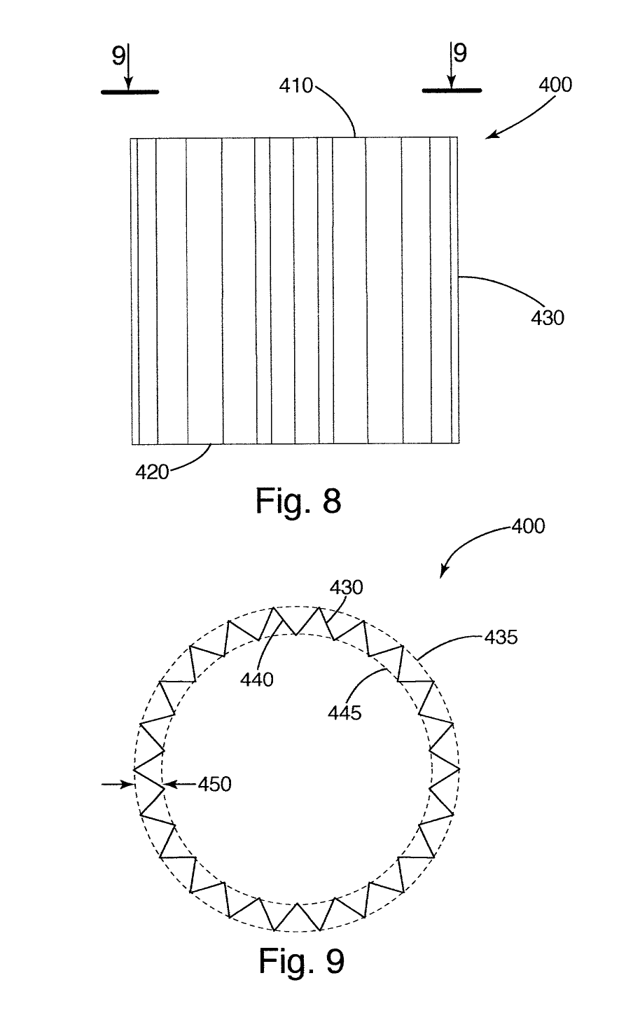

With reference now to FIGS. 8 and 9, it is illustrated that outer filter element 400 is generally cylindrical in shape, with a top surface 410, a bottom surface 420, an outside surface 430, and an inside surface 440.

Outer filter element 400 is comprised of a material which is pre-pleated or capable of being pleated, preferably a polymer such as polyester, which is 95% or more effective in removing all particles greater than 20 microns in size. In an alternative embodiment, the outer filter element 400 is comprised of a pleated material, preferably a polymer such as polyester, which is 95% or more effective in removing all particles greater than 5 microns in size. In yet another embodiment, the outer filter element 400 is comprised of a pleated material, preferably a polymer such as polyester, which is 95% or more effective in removing all particles greater than 1 micron in size.

Pleated outer surface 430 defines outer diameter 435. Pleated inner surface 440 defines inside diameter 445. Pleat depth 450 is measured as one-half the difference between outer diameter 435 and inner diameter 445. In one embodiment, pleat depth 450 is between 2 and 7 millimeters. In another embodiment, pleat depth 450 is between 3 and 6 millimeters. In yet another embodiment, pleat depth 450 is between 4 and 5 millimeters.

In a preferred embodiment of the present invention, the outer surface area of outer filter element 400 is between 2 and 10 times greater than the area of outer surface 140 of inner filter element 100. In a more preferred embodiment, the outer surface area of outer filter element 400 is between 3 and 8 times greater than the area of outer surface 140 of inner filter element 100. In a more preferred embodiment, the outer surface area of outer filter element 400 is between 4 and 6 times greater than the area of outer surface 140 of inner filter element 100. In a more preferred embodiment, the outer surface area of outer filter element 400 is between 4.5 and 5.5 times greater than the area of outer surface 140 of inner filter element 100.

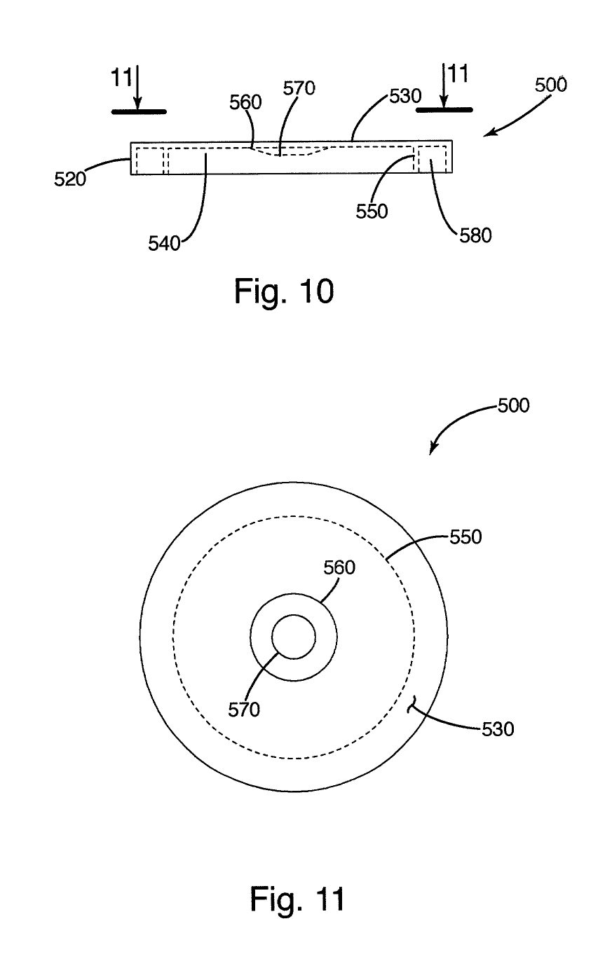

With reference now to FIGS. 10 and 11, outer top end cap 500 is generally circular in shape, with an outer surface 530, inner surface 540, raised lip 520, concentric raised conical section 560, and top cap central bore 570. Outer top end cap 500 is further comprised of an inner concentric raised lip 550. Raised lips 520 and 550 create a recess 580 which captures and is glued or otherwise attached to top surface 410 of outer filter element 400. One suitable adhesive used to attach outer top end cap 500 to outer filter element 400 is a polyethylene-based adhesive, although any suitable adhesive may be employed.

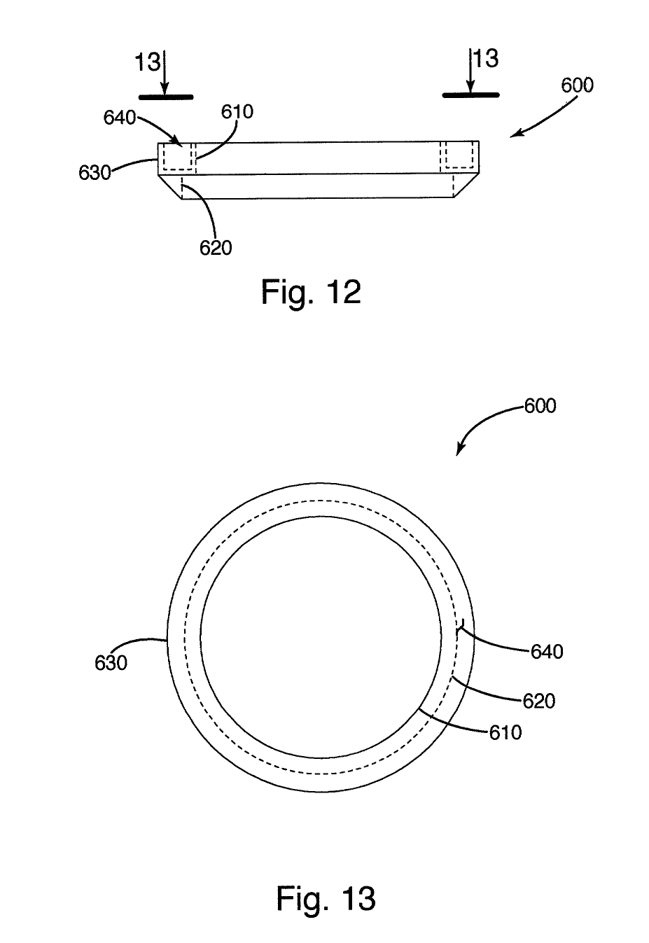

With reference now to FIGS. 12 and 13, outer bottom end cap 600 is generally cylindrical in shape, with an outer surface 630, a first inner diameter 620, and a raised inner lip 610. Raised lip 610 and outer surface 630 create a recess 640 which captures, and is glued or otherwise permanently attached to the bottom surface 420 of outer filter element 400. One suitable adhesive used to attach outer bottom end cap 600 to outer filter element 400 is a polyethylene-based adhesive, although any suitable adhesive may be employed.

The filter assembly of the above embodiment is assembled by sliding outer filter element 400 and attached outer bottom end cap 600 over inner filter element 100 so that both filter elements share a common longitudinal axis, and so that inside diameter 620 of outer bottom end cap 600 is in contact with sealing O-rings 354 of inner bottom end cap 300. Outer filter element 400 may be removably attached to inner filter element 100 by passing removable attachment device 800 through opening 570 of outer top end cap 500 and into concentric raised section 210 of inner top end cap 200. Outer filter element 400 may be separated and removed from inner filter element 100 to allow for cleaning or replacing of individual filter elements.

Although only a few exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention as defined in the following claims. In the claims, device-plus-function clauses are intended to cover the structure described herein as performing the recited function and not only structural equivalents, but also equivalent structures. Any reference to claims in the singular, for example using the articles “a”, “an”, “the”, or “said”, is not to be construed as limiting the to the singular.

We claim:

1. A filter assembly comprised of:
a first filter comprised of opposite first and second non-porous end caps and a carbon based filter interposed between the first and second end caps and arranged in a cylindrically shaped configuration to define a first central bore extending longitudinally through the first filter, the first end cap having an opening formed through the thickness thereof and being in communication with the central bore;
a second filter comprised of opposite third and fourth non-porous end caps and a filter interposed between the third and fourth end caps and arranged in a cylindrically shaped configuration to define a second central bore extending longitudinally through the second filter, the third end cap having an opening through the thickness thereof and being in communication with the central bore; and
wherein the first filter is removably inserted within the second filter such that both the first central bore and the second central bore share a common central longitudinal axis, and such that the third end cap is in sealing contact with the first end cap.

2. The filter assembly of claim 1, wherein:
the second filter is comprised of a pleated material with the pleats aligned in parallel with the central axis of the second filter.

3. The filter assembly of claim 1, wherein:
the fourth end cap has an opening formed through the thickness thereof, the opening in the fourth end cap being in communication with the second central bore.

4. The filter assembly of claim 1, wherein:
an elastomeric sealing O-ring is interposed between the first end cap and the third end cap

5. The filter assembly of claim 1, wherein:
the first filter is comprised of activated carbon.

6. The filter assembly of claim 1, wherein:
the first filter is comprised of a pressed block of activated carbon.

7. The filter assembly of claim 1, wherein:
the first filter is comprised of an extruded block of activated carbon.

8. The filter assembly of claim 1, further comprising:
a device mounted circumferencially around the second filter.

9. The filter assembly of claim 1, wherein:
the first end cap is adapted for insertion into the deck of a water treatment system.

10. The filter assembly of claim 2, wherein:
the outer surface area of the second filter is 2 to 10 times greater than the outer surface area of the first filter.

11. The filter assembly of claim 2, wherein:
the outer surface area of the second filter is 3 to 8 times greater than the outer surface area of the first filter.

12. The filter assembly of claim 2, wherein:
the outer surface area of the second filter is 4 to 6 times greater than the outer surface area of the first filter.

13. The filter assembly of claim 2, wherein:
the outer surface area of the second filter is 4.5 to 5.5 times greater than the outer surface area of the first filter.

14. The filter assembly of claim 2, wherein:
the pleat depth measures between 2 and 7 millimeters.

15. The filter assembly of claim 2, wherein:
the pleat depth measures between 3 and 6 millimeters.

16. The filter assembly of claim 2, wherein:
the pleat depth measures between 4 and 5 millimeters.

17. The filter assembly of claim 3, wherein:
the second end cap is further adapted to accept the attachment of a removable attachment device.

18. The filter assembly of claim 17, further comprising:
a removable attachment device inserted through the opening formed through the fourth end cap and attached to the second end cap.

19. The filter assembly of claim 18, wherein:
the removable attachment device is a threaded bolt.

20. The filter assembly of claim 18, wherein:
the removable attachment device is a screw.

21. The filter assembly of claim 18, wherein:
the removable attachment device is a clip.

22. The filter assembly of claim 18, wherein:
the removable attachment device is a magnet.

23. The filter assembly of claim 8, wherein:
the device mounted circumferencially around the second filter is comprised of a plurality of straps.

24. The filter assembly of claim 8, wherein:
the device mounted circumferencially around the second filter is comprised of a webbed wrap.

25. A filter assembly comprised of:
a first filter comprised of opposite first and second non-porous end caps and a pressed activated carbon block filter interposed between the first and second end caps and arranged in a cylindrically shaped configuration to define a central bore extending longitudinally through the first filter, the first end cap having an opening formed through the thickness thereof and being in communication with the central bore and the second end cap comprised of a concentric raised section extending within the central bore and adapted to accept an attachment device;
a second filter comprised of opposite third and fourth non-porous end caps and a filter interposed between the third and fourth end caps and arranged in a cylindrically shaped configuration to define a central bore extending longitudinally through the second filter, the third end cap having an opening through the thickness thereof and being in communication with the central bore, the fourth end cap having an opening formed through the thickness thereof and being in communication with the central bore;
wherein the second filter is comprised of a pleated material with an outer surface area 5 times greater than the outer surface area of the first filter; and
wherein the first filter is removably inserted within the second filter such that both share a common central longitudinal axis, and such that the third end cap is in sealing contact with the first end cap.

26. The filter assembly of claim 25, wherein:
an elastomeric sealing O-ring is interposed between the first end cap and the third end cap.

27. The filter assembly of claim 1, wherein:
The first end cap is adapted for insertion into the deck of a water treatment system.

28. The filter assembly of claim 25, further comprising:
a removable attachment device inserted through the opening formed through the fourth end cap and attached to the second end cap.

29. The filter assembly of claim 28, wherein
the removable attachment device is a threaded bolt.

30. The filter assembly of claim 28, wherein:
the removable attachment device is a screw.

31. The filter assembly of claim 28, wherein:
the removable attachment device is a clip.

32. The filter assembly of claim 28, wherein:
the removable attachment device is a magnet.

33. A filter assembly comprised of:
a first filter comprised of opposite first and second non-porous end caps and a pressed activated carbon block filter interposed between the first and second end caps and arranged in a cylindrically shaped configuration to define a central bore extending longitudinally through the first filter, the first end cap having an opening formed through the thickness thereof and being in communication with the central bore, the first end cap being further adapted for insertion into the deck of a water treatment system, and the second end cap comprised of a concentric raised section extending within the central bore and adapted to accept an attachment device;
a second filter comprised of opposite third and fourth non-porous end caps and a filter interposed between the third and fourth end caps and arranged in a cylindrically shaped configuration to define a central bore extending longitudinally through the second filter, the third end cap having an opening through the thickness thereof and being in communication with the central bore, the fourth end cap having an opening formed through the thickness thereof and being in communication with the central bore;
a removable attachment device inserted through the opening formed through the fourth end cap and removably attached to the second end cap; and
wherein the second filter is comprised of a pleated material with an outer surface area 5 times greater than the outer surface area of the first filter; and
wherein the first filter is removably inserted within the second filter such that both share a common central longitudinal axis, and such that the third end cap is in sealing contact with the first end cap.
